(19) United States
(12) Patent Application Publication
(10) Pub. No.: US 2015/0177987 A1
(43) Pub. Date: Jun. 25, 2015

(54) AUGMENTING MEMORY CAPACITY FOR KEY VALUE CACHE

(71) Applicants: Kevin T. Lim, La Honda, CA (US); Alvin AuYoung, San Jose, CA (US)

(72) Inventors: Kevin T. Lim, La Honda, CA (US); Alvin AuYoung, San Jose, CA (US)

(21) Appl. No.: 14/405,899

(22) PCT Filed: Jun. 8, 2012
(86) PCT No.: PCT/US2012/041536

§ 371 Date: Dec. 5, 2014

(51) Int. Cl. G06F 3/06; G06F 12/08

(52) U.S. Cl. CPC G06F 3/0607; G06F 12/0802; G06F 3/0631; G06F 3/0656; G06F 3/0673; G06F 2212/601; G06F 2212/608

(57) ABSTRACT

Methods, systems, and computer-readable and executable instructions are provided for augmenting memory capacity. Augmenting memory capacity can include connecting a memory blade to a hyperscale computing system via an interconnect, wherein the hyperscale computing system includes an in-memory key-value cache, and augmenting memory capacity to the hyperscale computing system using the memory blade.

### BACKGROUND

In-memory key-value caches can be used for interactive Web-tier applications to improve performance. To achieve improved performance, key-value caches have simultaneous requirements of providing low-latency, high throughput access to objects and providing capacity to store a large number of such objects.

### BRIEF DESCRIPTION OF THE DRAWINGS

FIG. 1 is a block diagram illustrating an example of a system according to the present disclosure.

FIG. 2 is a block diagram illustrating an example of a method for providing memory capacity according to the present disclosure.

FIG. 3 is a block diagram illustrating a processing resource, a memory resource, and computer-readable medium according to the present disclosure.

### DETAILED DESCRIPTION

A memory blade can be used to provide an expanded capacity for hyperscale computing systems which are memory-constrained, such as, for example, a hyperscale computing system including an in-memory key-value cache. Key-value caches may require larger memory capacities provided by high-speed storage (e.g., dynamic random-access memory (DRAM) speed storage) as compared to other caches, and may also require scale-out deployments. Hyperscale computing systems can provide for such scale-out deployment of key-value caches, but may not have a capability to provide adequate memory capacity due to both physical constraints and use of particular processors (e.g., 32-bit processors). Attaching a memory blade via a high-speed interconnect (e.g., peripheral component interconnect express (PCIe)) can enable hyperscale systems to reach necessary memory capacity for key-value caches by providing a larger memory capacity memory compared to a key-value cache alone.

Examples of the present disclosure may include methods, systems, and computer-readable and executable instructions and/or logic. An example method for augmenting memory capacity can include connecting a memory blade to a hyperscale computing system via an interconnect, wherein the hyperscale computing system includes an in-memory key-value cache, and augmenting memory capacity to the hyperscale computing system using the memory blade.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators“N”, “P”, “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

In-memory key-value caches such as memcached can be used for interactive Web-tier applications to improve performance. Specifically, key-value caches used in this context have simultaneous requirements of providing low-latency, high throughput access to objects, and providing capacity to store a number of such objects. Key-value caches may require many gigabytes of capacity (e.g., at least 64 GB memory per node) to cache enough data to achieve required hit rates. Hyperscale systems can utilize designs in which compute blades are highly memory constrained, due to physical space limitations and because they utilize 32-bit processors. These constraints can limit such systems to approximately 4 GB of memory, well below an expected capacity of memcached servers. However, such hyperscale systems have otherwise desirable properties for key-value cache systems (e.g., memcached), which require high I/O performance and high scale-out, but do not need significant amounts of compute capacity.

As will be discussed further herein, hyperscale computing systems can be used with in-memory key-value caches by providing expanded memory capacity using disaggregated memory. Disaggregated memory can include separating a portion of memory resources from servers and organizing and sharing the memory resources, for example. This can enable data center administrators to provision the number of hyperscale servers to meet expected throughput, while independently utilizing a memory blade to meet the desired memory capacity. Disaggregated memory architectures can provide a remote memory capacity through a memory blade, connected via a high-speed interconnect such as PCI Express (PCIe). In such architectures, local dynamic random-access memory (DRAM) can be augmented with remote DRAM. This remote capacity can be bigger than local DRAM by specializing the memory blade's design, and can offer these capacities at reduced costs.

In the case of in-memory key-value caches, disaggregated memory can provide the DRAM capacities needed, and a filter can be used to avoid degrading performance of the system. For example, a filter can be used to provide detection of a possibility of presence of data on the remote memory, allowing the system to determine if remote memory must be accessed. In some examples, remote memory accesses can be avoided, preventing additional latency being added relative to a baseline implementation of a key-value cache. In some examples, if a hyperscale computing system is physically memory constrained, disaggregated memory can be used to provide a separate memory blade device that is able to address the entire capacity of a memory region (e.g., hundreds of GBs to tens of TBs). This capability can decouple providing an expanded key-value cache capacity from the ability for the hyperscale servers to address large memory.

Hyperscale computing systems are designed to achieve a performance/cost advantage versus traditional rack- and blade-mounted servers when deployed with a targeted scale that may be larger when compared to other scales (e.g., millions of individual servers). One of the drivers of those efficiency levels is an increased level of compute density per cubic foot of volume. Therefore, an important design goal of such hyperscale systems is to achieve performance (e.g., maximum performance) with limited thermal budget and limited physical real-estate. Hyperscale computing systems can include a microblade design where an individual server is very small to enable very dense server deployments. As a result, there can be physical constraints on space for DRAM. Additionally, such hyperscale systems can utilize lower-cost and lower-power processors as compared to other systems to enable scale-out within a certain thermal budget. For example, current low-power processors may include 32-bit processors. The combination of these constraints can lead to hyperscale computing systems that are unable to have sufficient DRAM capacity for key-value caches such as memcached.

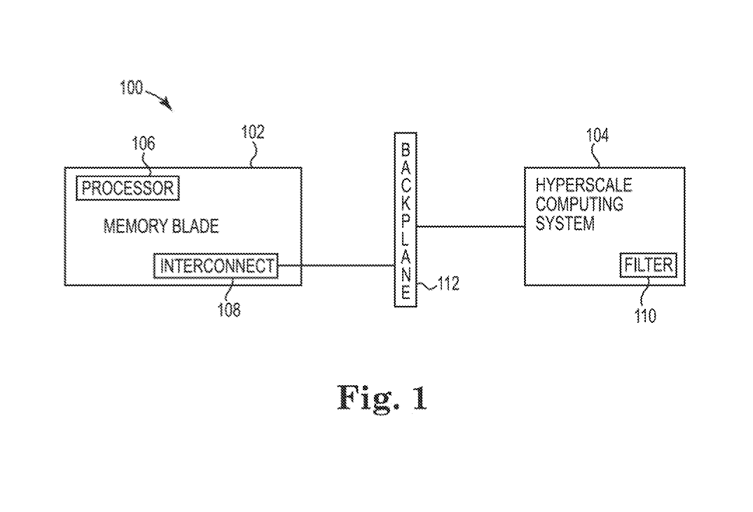

FIG. 1 is a block diagram illustrating an example of a system 100 according to the present disclosure. System 100 can include a memory blade 102 connected to a hyperscale computing system 104 via an interconnect 108 and backplane 112. Interconnect 108 can include a PCIe, for example.

In some examples, a PCIe-attached memory blade 102 is used to provide expanded capacity for hyperscale computing system 104. Memory blade 102 includes an interconnect 108 (e.g., a PCIe bridge), a light-weight (e.g., 32-bit) processor 106, and DRAM capacity. The light-weight processor 106 can handle general purpose functionality to support memcached extensions. Memory blade 102 can be used by multiple servers simultaneously, each server having its own dedicated interconnect lanes connecting the server to memory blade 102. In some embodiments, memory blade 102 is physically remote memory.

Memory blade 102 can include, for example, a tray with a capacity-optimized board, a number of dual in-line memory module (DIMM) slots along with buffer-on-board chips, a number of gigabytes to terabytes of DRAM, a light-weight processor (e.g., processor 106), a number of memory controllers to communicate with the DRAM, and an interconnect bridge such as a PCIe bridge. The memory blade can be in the same form factor blade as the compute blades, or in a separate form factor depending on space constraints.

To provide expanded capacity for hyperscale computing system 104 targeting the use case of memcached, memory blade 102 can be accessed through a narrow interface exporting the same commands as a typical memcached server (put, get, incr, decr, remove). In some embodiments, hyperscale computing system 104 can include a number of hyperscale servers.

Upon receiving a memcached request (e.g., a memcached request for data), a hyperscale server within hyperscale computing system 104 can check its local memcached contents to see if it can service the request. If it hits in its local cache, the operation can proceed as in the unmodified system—a deployment with a standard stand-alone server (e.g., without a remote memory blade) However, if it misses in its local cache, the server can determine if it should send the request to the memory blade 102.

Memory blade 102, upon receiving the request, can examine (e.g., look up) its cache contents associated with that server, either replying with the data requested, updating the data requested, or replying that it does not have the data. The memory blade itself can become populated with data as memcached entries are evicted from the server due to capacity constraints. Instead of deleting the data, those items can be put into the memory blade. The memory blade can also evict items if it runs out of space, and those items can be deleted. When returning items, memory blade 102 can optionally remove those items from its cache if they will be promoted to the server's cache; this can be done through the server actively indicating that it wants to promote the item it is requesting when sending the access to the memory blade.

Because extra time may be required to access the remote memory, accesses to remote memory can be reduced when it is likely to not have useful content in some embodiments. A filter 110 can be used to reduce accesses to memory blade 102, and filter 110 can be kept on the server within hyperscale computing system 104. Filter 110 can be accessed by hashing a key to generate a filter index, and a key/value pair can be looked up, where the key/value pair indicates a potential presence of an item on the memory blade.

In some examples, if the value corresponding to a key is greater than 1, memory blade 102 may potentially have that key; otherwise if it is a 0, memory blade 104 is guaranteed to not have the key. In such a design, a filter 110 will not produce false negative. Filter 110 can be updated when items are evicted from local cache to memory blade 102, and at that time filter 110 can be indexed into and the value at that index can be incremented. When items are returned from memory blade 102 (or evicted), the filter's 110 value for that index can be decremented. By accessing filter 110 prior to accessing memory blade 102, a faster determination can be made if the memory blade should be accessed or not.

In some embodiments, due to a limited capacity of local memory within hyperscale computing system 104, policies to increase (e.g., optimize) the use of local memory capacity can be employed. For example, expired items can be actively evicted from local memory. By default, memcached uses lazy eviction of expired items; if an item passes its expiration time, it is only evicted once it is accessed again. In some examples of the present disclosure, a hyperscale server can actively find expired items and evict them from the local cache. These operations can be performed during accesses to memory blade 102, while the server is waiting for a response from memory blade 102. For example, this can result in work performed while overlapping the access and transfer time to memory blade 102.

In some examples, memory blade 102 can be shared by multiple hyperscale servers within hyperscale computing system 104. Contents of memory blade 102 can either be statically partitioned, providing each server with a set amount of memory, or be shared among all servers (assuming they are all part of the same memcached cluster and are allowed to access the same content). Static partitioning can help isolate the quality of service of each server, ensuring that one server does not dominate a cache's capacity.

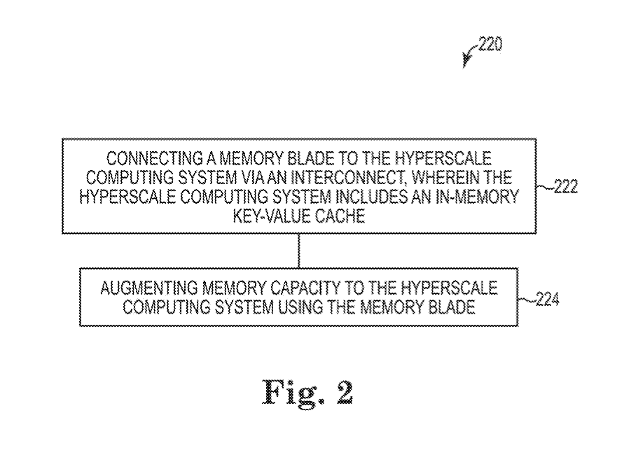

FIG. 2 is a block diagram illustrating an example of a method 220 for augmenting memory capacity according to the present disclosure. At 222, a memory blade is connected to a hyperscale computing system via an interconnect. In a number of embodiments, the hyperscale computing system includes an in-memory key-value cache. The interconnect can include a PCIe, in some examples.

At 224, memory capacity is augmented to the hyperscale computing system using the memory blade. In some examples, an interconnect-attached memory blade can be used to provide expanded capacity for a hyperscale computing system, as discussed with respect to FIG. 1. For example, a memcached capacity can be divided among a local cache and the memory blade, resulting in expanded cache.

In some examples, a filter can be utilized to determine whether to access the memory blade for the expanded memory capacity. For example, a filter can be used to determine whether to access the memory blade for client-requested data.

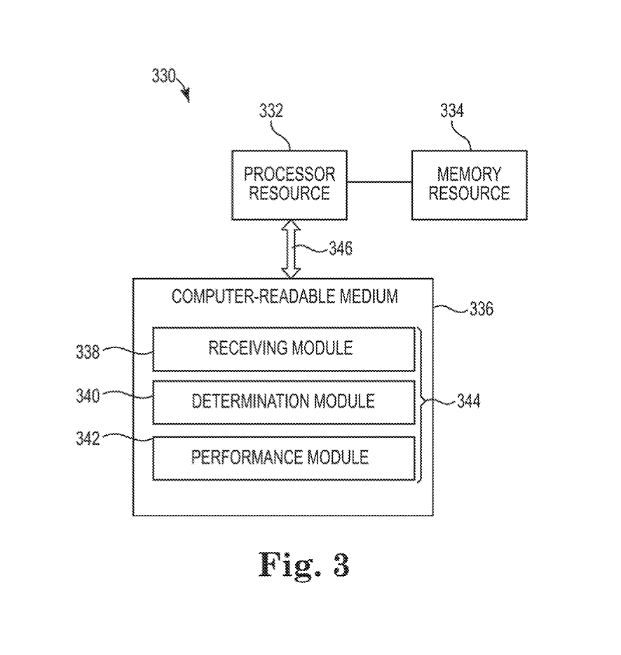

FIG. 3 illustrates an example computing device 330 according to an example of the present disclosure. The computing device 330 can utilize software, hardware, firmware, and/or logic to perform a number of functions.

The computing device 330 can be a combination of hardware and program instructions configured to perform a number of functions. The hardware, for example can include one or more processing resources 332, computer-readable medium (CRM) 336, etc. The program instructions (e.g., computer-readable instructions (CRI) 344) can include instructions stored on the CRM 336 and executable by the processing resources 332 to implement a desired function (e.g. augmenting memory capacity for a hyperscale computing system, etc.).

CRM 336 can be in communication with a number of processing resources of more or fewer than 332. The processing resources 332 can be in communication with a tangible non-transitory CRM 336 storing a set of CRI 344 executable by one or more of the processing resources 332, as described herein. The CRI 344 can also be stored in remote memory managed by a server and represent an installation package that can be downloaded, installed, and executed. The computing device 330 can include memory resources 334, and the processing resources 332 can be coupled to the memory resources 334.

Processing resources 332 can execute CRI 344 that can be stored on an internal or external non-transitory CRM 336. The processing resources 332 can execute CRI 344 to perform various functions, including the functions described in FIG. 1 and FIG. 2.

The CRI 344 can include a number of modules 338, 340, and 342. The number of modules 338, 340, and 342 can include CRI that when executed by the processing resources 332 can perform a number of functions.

The number of modules 338, 340, and 342 can be sub-modules of other modules. For example the receiving module 338 and the determination module 340 can be sub-modules and/or contained within a single module. Furthermore, the number of modules 338, 340, and 342 can comprise individual modules separate and distinct from one another.

A receiving module 338 can comprise CRI 344 and can be executed by the processing resources 332 to receive a memcached request to a hyperscale computing system. In some examples, the hyperscale computing system can include a local memcached caching system and is connected to a memory blade via an interconnect (e.g., PCIe).

A determination module 364 can comprise CRI 344 and can be executed by the processing resources 332 to determine whether the memcached request can be serviced on the hyperscale computing system by analyzing contents of the local memcached caching system.

A performance module 342 can comprise CRI 344 and can be executed by the processing resources 332 to perform an action based on the determination. For example, the instructions executable to perform an action can include instructions executable to send the memcached request to the memory blade, in response to a determination that the memcached request cannot be serviced on the hyperscale computing system.

In a number of embodiments, the instructions executable to perform an action can include instructions executable to not send the request to the memory blade, in response to a determination that the request cannot be serviced on the hyperscale computing system and based on at least one of filtering requested data from the memcached request and evicting requested data from the memcached request. For example, CRM 336 can include instructions executable to evict expired data from the local memcached caching system while the instructions to look up cache contents within the memory blade are executed.

In a number of embodiments, the instructions to send the request to the memory blade can include instructions executable to look up cache contents within the memory blade and reply to the hyperscale computing system with requested data from the memcached request. The instructions executable to send the request to the memory blade can include instructions executable to look up cache contents within the memory blade and reply to the hyperscale computing system with updated requested data from the memcached request. In some examples, the instructions executable to send the request to the memory blade can include instructions executable to look up cache contents within the memory blade and reply to the hyperscale computing system that the memory blade does not include requested data from the memcached request.

In some examples of the present disclosure, the instructions executable to perform the action, can include instructions executable to proceed, in response to a determination that the request can be serviced on the hyperscale computing system, as an unmodified (e.g., default) system, where an unmodified system refers to behavior of a deployment of a stand-alone server (e.g., a hyperscale system without a remote memory blade, and/or a standard non-hyperscale server).

A non-transitory CRM 336, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 336 can be integral, or communicatively coupled, to a computing device, in a wired and/or a wireless manner. For example, the non-transitory CRM 336 can be an internal memory, a portable memory, a portable disk, or a memory associated with another computing resource (e.g., enabling CRTs 344 to be transferred and/or executed across a network such as the Internet).

The CRM 336 can be in communication with the processing resources 332 via a communication path 346. The communication path 346 can be local or remote to a machine (e.g., a computer) associated with the processing resources 332. Examples of a local communication path 346 can include an electronic bus internal to a machine (e.g., a computer) where the CRM 336 is one of volatile, non-volatile, fixed, and/or removable storage medium in communication with the processing resources 332 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 346 can be such that the CRM 336 is remote from the processing resources, (e.g., processing resources 332) such as in a network connection between the CRM 336 and the processing resources (e.g., processing resources 332). That is, the communication path 346 can be a network connection. Examples of such a network connection can include a local area network (LAN), wide area network (WAN), personal area network (PAN), and the Internet, among others. In such examples, the CRM 336 can be associated with a first computing device and the processing resources 332 can be associated with a second computing device (e.g., a Java® server). For example, a processing resource 332 can be in communication with a CRM 336, wherein the CRM 336 includes a set of instructions and wherein the processing resource 332 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for augmenting memory capacity for a hyperscale computing system, comprising:
connecting a memory blade to the hyperscale computing system via an interconnect, wherein the hyperscale computing system includes an in-memory key-value cache; and
augmenting memory capacity to the hyperscale computing system using the memory blade.

2. The method of claim 1, further comprising determining, using a filter, whether to access the memory blade for the memory capacity.

3. The method of claim 1, wherein the in-memory key-value cache includes a memcached caching system.

4. The method of claim 1, wherein the interconnect includes a peripheral component interconnect express expansion bus.

5. A non-transitory computer-readable medium storing a set of instructions for augmenting memory capacity to a hyperscale computing system executable by a processing resource to:
receive a memcached request to the hyperscale computing system, wherein the hyperscale computing system includes a local memcached caching system and is connected to a memory blade via a peripheral component interconnect express expansion bus;
determine whether the memcached request can be serviced on the hyperscale computing system by analyzing contents of the local memcached caching system; and
perform an action based on the determination.

6. The non-transitory computer-readable medium of claim 7, wherein the instructions executable to perform the action include instructions executable to send the memcached request to the memory blade, in response to a determination that the memcached request cannot be serviced on the hyperscale computing system.

7. The non-transitory computer-readable medium of claim 6, wherein the instructions to send the request to the memory blade further include instructions executable to look up cache contents within the memory blade and reply to the hyperscale computing system with requested data from the memcached request.

8. The non-transitory computer-readable medium of claim 6, wherein the instructions to send the request to the memory blade further include instructions executable to look up cache contents within the memory blade and reply to the hyperscale computing system with updated requested data from the memcached request.

9. The non-transitory computer-readable medium of claim 6, wherein the instructions to send the request to the memory blade further include instructions executable to look up cache contents within the memory blade and reply to the hyperscale computing system that the memory blade does not include requested data from the memcached request.

10. The non-transitory computer-readable medium of claim 5, wherein the instructions executable to perform the action include instructions executable to not send the request to the memory blade, in response to a determination that the request cannot be serviced on the hyperscale computing system and based on at least one of filtering requested data from the memcached request and evicting requested data from the memcached request.

11. The non-transitory computer-readable medium of claim 5, wherein the instructions executable to perform the action, include instructions executable to proceed, in response to a determination that the request can be serviced on the hyperscale computing system, as an unmodified system.

12. The non-transitory computer-readable medium of claim 7, further comprising instructions executable to evict expired data from the local memcached caching system while the instructions to look up cache contents within the memory blade are executed.

13. A system, comprising:
a memory blade for augmenting memory capacity to a hyperscale computing system; and
the hyperscale computing system connected to the memory blade via a peripheral component interconnect express expansion bus, the hyperscale computing system including:
a memcached caching system; and
a filter to detect a presence of data on the memory blade and determine whether to access the data.

14. The system of claim 12, wherein the filter produces no false negatives.

15. The system of claim 12, wherein the memory blade is shared by a plurality of servers of the hyperscale computing system and contents of the memory blade are statically partitioned among the plurality of servers.
